(19) United States
(12) Patent Application Publication
(10) Pub. No.: US 2024/0359355 A1
(43) Pub. Date: Oct. 31, 2024

(54) MULTI-PURPOSE SAW

(71) Applicant: Black & Decker Inc., New Britain, CT (US)

(72) Inventor: Austin L. Ganzermiller, Reisterstown, MD (US)

(21) Appl. No.: 18/741,265

(22) Filed: Jun. 12, 2024

Related U.S. Application Data
(63) Continuation-in-part of application No. 18/647,665, filed on Apr. 26, 2024.
(60) Provisional application No. 63/498,443, filed on Apr. 26, 2023.

(51) Int. Cl. B27B 5/16; B27B 27/08; B27G 19/08

(52) U.S. Cl. CPC B27B 5/165; B27B 27/08; B27G 19/08; B27G 19/025

(57) ABSTRACT

A power tool system includes a base having a top surface, a bottom surface, and an opening between the top surface and the bottom surface. The power tool system includes a support structure passing through the opening in the base, the support structure having a first end and a second end, a power-driven tool positioned above the top surface of the base and mounted to the first end of the support structure, and a moving mechanism disposed below the top surface of the base and coupled to the second end of the support structure.

### CROSS-REFERENCE TO RELATED APPLICATION

This application is a continuation-in-part application of U.S. application Ser. No. 18/647,665, filed Apr. 26, 2024, and titled “Multi-Motor Drive System,” which claims priority to and the benefit of U.S. Provisional Application No. 63/498,443, filed Apr. 26, 2023, and titled “Multi-Motor Drive System,” both of which are incorporated herein by reference in their entireties.

### TECHNICAL FIELD

This description relates to a multi-purpose saw.

### BACKGROUND

A saw may be used to cut numerous different types of workpieces including wood, metal, composite, plastic, laminate, and the like. In general, a saw includes a motor that generates a driving force, for example, a rotary force or torque, that is transmitted to a blade, causing the blade to rotate and perform a cutting operation on a workpiece.

### SUMMARY

In some aspects, the techniques described herein relate to a power tool system, including: a base having a top surface, a bottom surface, and an opening between the top surface and the bottom surface; a support structure passing through the opening in the base, the support structure having a first end and a second end; a power-driven tool positioned above the top surface of the base and mounted to the first end of the support structure; and a moving mechanism disposed below the top surface of the base and coupled to the second end of the support structure.

In some aspects, the techniques described herein relate to a power tool system, wherein the power-driven tool and the support structure are movable along the opening in the base to engage a workpiece positioned on the top surface of the base.

In some aspects, the techniques described herein relate to a power tool system, wherein the support structure includes a riving knife.

In some aspects, the techniques described herein relate to a power tool system, wherein the moving mechanism includes: a rail system fixed to the base below the top surface; and a carrier having an opening to receive and secure the second end of the support structure, the carrier movable along the rail system.

In some aspects, the techniques described herein relate to a power tool system, wherein: the rail system includes a first rail and a second rail; and the carrier includes at least one roller to roll along the first rail and at least one roller to roll along the second rail.

In some aspects, the techniques described herein relate to a power tool system, wherein the power-driven tool includes a saw configured to rotatably drive a blade.

In some aspects, the techniques described herein relate to a power tool system, wherein the blade is coplanar with the support structure.

In some aspects, the techniques described herein relate to a power tool system, wherein: the saw includes a handle; and a center plane of the handle is coplanar with the blade and the support structure.

In some aspects, the techniques described herein relate to a power tool system, wherein: the support structure defines a longitudinal plane; and a center of gravity of the power-driven tool is aligned along the longitudinal plane.

In some aspects, the techniques described herein relate to a power tool system, wherein: the power-driven tool includes a saw having a handle, the saw configured to rotatably drive a blade; and the center of gravity of the saw is aligned along a center plane of the handle.

In some aspects, the techniques described herein relate to a power tool system, wherein the base includes: a first fence that is parallel to the opening in the base; and a second fence having a first position that is parallel to the opening in the base and a second position that is perpendicular to the opening in the base.

In some aspects, the techniques described herein relate to a power tool system, wherein: the first fence is movable across the top surface of the base in a position parallel to the opening in the base; and the second fence pivots about a point from the first position to the second position.

In some aspects, the techniques described herein relate to a power tool system, wherein: an end of the base includes a cavity between the top surface and the bottom surface, the cavity is sized to receive the second fence; and the second fence is rotatable and movable from the top surface of the base into the cavity between the top surface and the bottom surface.

In some aspects, the techniques described herein relate to a power tool system, wherein: the top surface of the base includes a cavity, wherein the cavity is sized to receive the second fence; and the second fence is rotatable and movable into the cavity.

In some aspects, the techniques described herein relate to a power tool system, including: a base having a top surface, a bottom surface, and an opening between the top surface and the bottom surface; a support structure passing through the opening in the base, the support structure having a first end and a second end; a power-driven tool positioned above the top surface of the base and mounted to the first end of the support structure, the power-driven tool including a blade aligned along a plane defined by the support structure with a center of gravity of the power-driven tool in alignment with the plane; and a moving mechanism disposed below the top surface of the base and coupled to the second end of the support structure.

In some aspects, the techniques described herein relate to a power tool system, wherein the power-driven tool includes a handle having a center of the handle aligned along the plane.

In some aspects, the techniques described herein relate to a power tool system, wherein the center of gravity is located in an approximate middle of the power-driven tool.

In some aspects, the techniques described herein relate to a power tool system, wherein the power-driven tool includes a saw.

In some aspects, the techniques described herein relate to a power tool system, including: a base having a top surface, a bottom surface, and an opening between the top surface and the bottom surface; a support structure passing through the opening in the base, the support structure having a first end and a second end; a power-driven tool positioned above the top surface of the base and mounted to the first end of the support structure, the power-driven tool including a motor housing; a multi-motor drive unit disposed in the motor housing to drive the power-driven tool; and a moving mechanism disposed below the top surface of the base and coupled to the second end of the support structure.

In some aspects, the techniques described herein relate to a power tool system, wherein the power-driven tool includes a saw configured to rotatably drive a blade using the multi-motor drive unit.

In some aspects, the techniques described herein relate to a power tool system, wherein the blade is coplanar with the support structure.

In some aspects, the techniques described herein relate to a power tool system, wherein: the saw includes a handle; and a center plane of the handle is coplanar with the blade and the support structure with a center of gravity of the saw aligned with the center plane of the handle, the blade, and the support structure.

In some aspects, the techniques described herein relate to a power tool system, wherein the center of gravity is located in an approximate middle of the saw.

The details of one or more implementations are set forth in the accompanying drawings and the description below. Other features will be apparent from the description and drawings, and from the claims.

### BRIEF DESCRIPTION OF THE DRAWINGS

FIG. 1 depicts a rear, left isometric view of an example multi-purpose saw.

FIG. 2 depicts a front, left isometric view of the multi-purpose saw of FIG. 1.

FIG. 3 depicts a rear, right isometric view of the multi-purpose saw of FIG. 1.

FIG. 4 depicts a front, right isometric view of the multi-purpose saw of FIG. 1.

FIG. 5 depicts a front elevation view of the multi-purpose saw of FIG. 1.

FIG. 6 depicts a left side elevation view of the multi-purpose saw of FIG. 1.

FIG. 7 depicts a rear elevation view of the multi-purpose saw of FIG. 1.

FIG. 8 depicts a right side elevation view of the multi-purpose saw of FIG. 1.

FIG. 9 depicts a front, left isometric view of the multi-purpose saw of FIG. 1 with the second fence in an operational state on the top surface of the base.

FIG. 10 depicts a front, left isometric view of the multi-purpose saw of FIG. 1 with the second fence in a stored state in an opening between the top surface and the bottom surface of the base.

FIG. 11 depicts a rear, right isometric view of the multi-purpose saw of FIG. 1 with the base removed, but with the first fence and the second track illustrated for reference.

FIG. 12 depicts an exploded view of the multi-purpose saw of FIG. 11 without the first fence and the second track.

FIG. 13 depicts the detail area A of FIG. 3, without the base.

FIG. 14 depicts a rear, left, partially exploded isometric view of the support structure and the moving mechanism of the multi-purpose saw.

FIG. 15 depicts a front view of the partially exploded view of FIG. 14.

FIG. 16 depicts a rear, right, partially exploded isometric view of the support structure and the moving mechanism of the multi-purpose saw.

FIG. 17A depicts a top view of the multi-purpose saw of FIG. 1.

FIG. 17B depicts a cross-section view of the multi-purpose saw of FIG. 1 with a partial cross-section of the base taken along section line A-A of FIG. 17A.

FIG. 18 depicts a top view of the carrier of FIGS. 12-16.

FIG. 19 depicts a rear, left isometric view of the carrier of FIG. 18.

FIG. 20 depicts a bottom, left isometric view of the carrier of FIG. 18.

FIG. 21 depicts front, left exploded view of the carrier of FIG. 18.

FIG. 22 depicts a rear, left isometric view of the support structure and the base.

FIG. 23 depicts a rear, left isometric view of the support structure.

FIG. 24 depicts a rear, right isometric view of the multi-purpose saw of FIG. 1 with the gears exposed.

FIG. 25 depicts a rear, left isometric view of the multi-purpose saw of FIG. 1 with the motors exposed.

FIG. 26 depicts a front, left isometric view of an example multi-purpose saw having an alternate implementation of a second fence in a first position.

FIG. 27 depicts a top view of the multi-purpose saw of FIG. 26 with the second fence in a first position.

FIG. 28 depicts a front, left isometric view of the multi-purpose saw of FIG. 26 with the second fence in a second position.

FIG. 29 depicts a top view of the multi-purpose saw of FIG. 26 with the second fence in a second position.

FIG. 30 depicts a front, left isometric view of the multi-purpose saw of FIG. 26 with the second fence in a third position.

FIG. 31 depicts a front, left isometric view of the multi-purpose saw of FIG. 26 with the second fence stowed within the top surface of the base.

FIG. 32 depicts a top view of the multi-purpose saw of FIG. 26 with the second fence in a stowed position.

### DETAILED DESCRIPTION

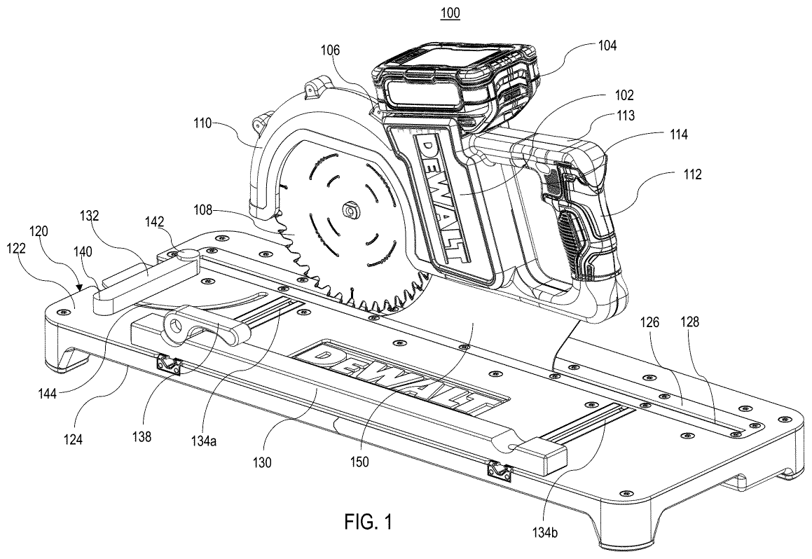

FIGS. 1-8 illustrate an example power tool system, in the form of an example multi-purpose saw 100. The multi-purpose saw 100 may be used to cut numerous different types of workpieces including wood, metal, composite, plastic, laminate, vinyl, tile, and the like. The multi-purpose saw 100 may be used to cut solid, engineered, and laminate flooring including luxury vinyl planks (LVP) and luxury vinyl tile (LVT). The multi-purpose saw 100 may make different types of cuts including cross cuts, rip cuts, and miter cuts.

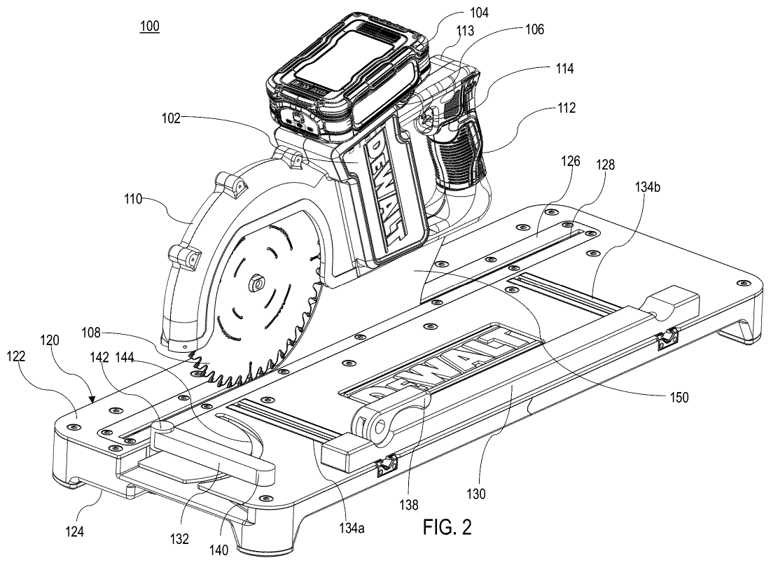

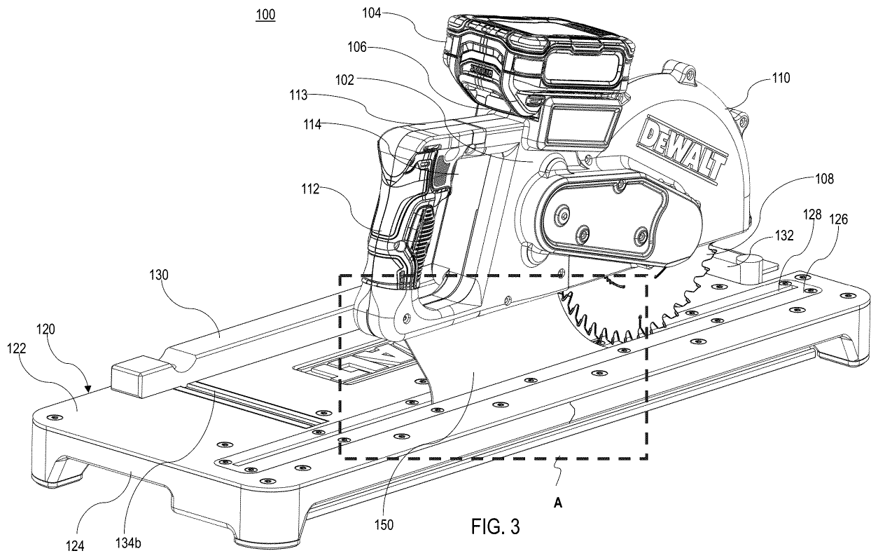

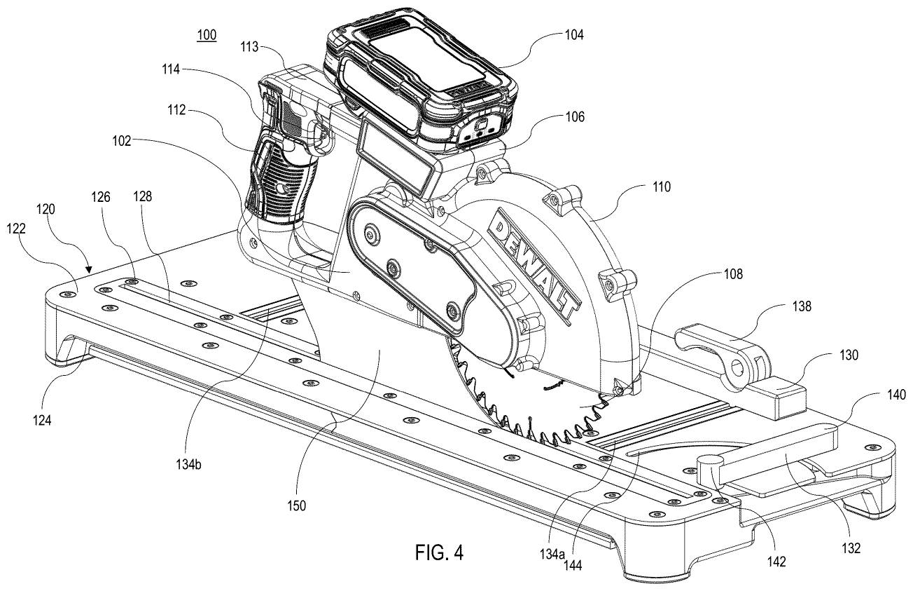

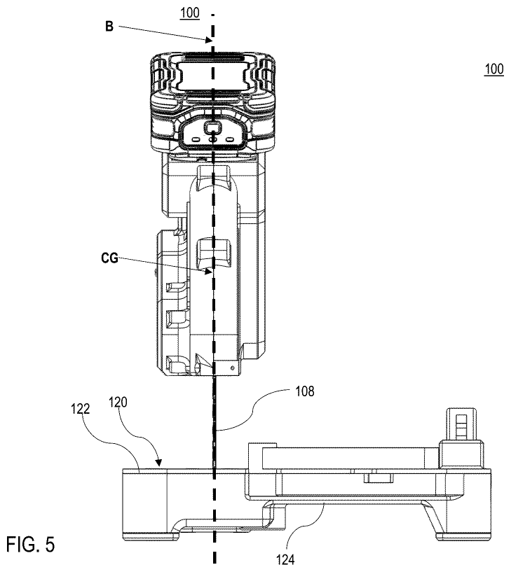

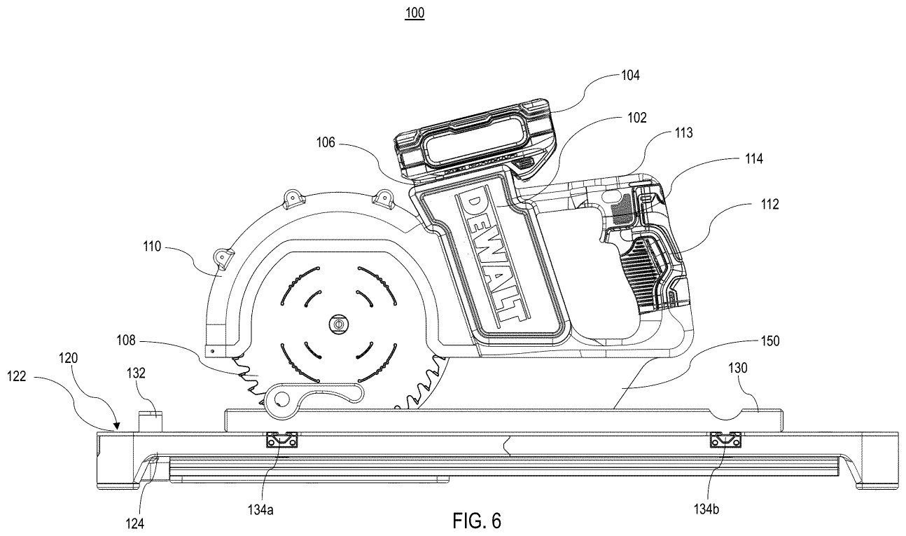

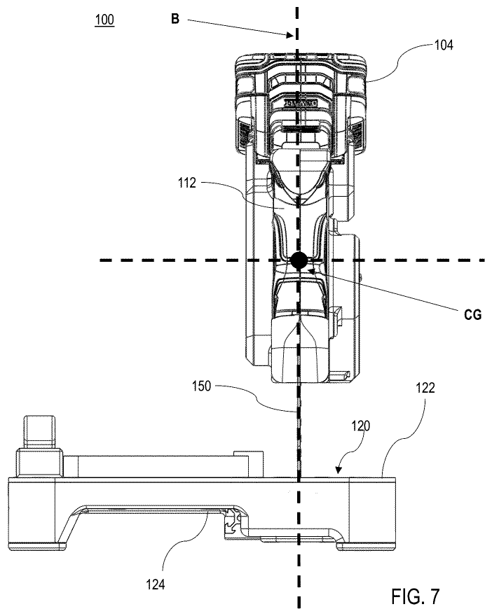

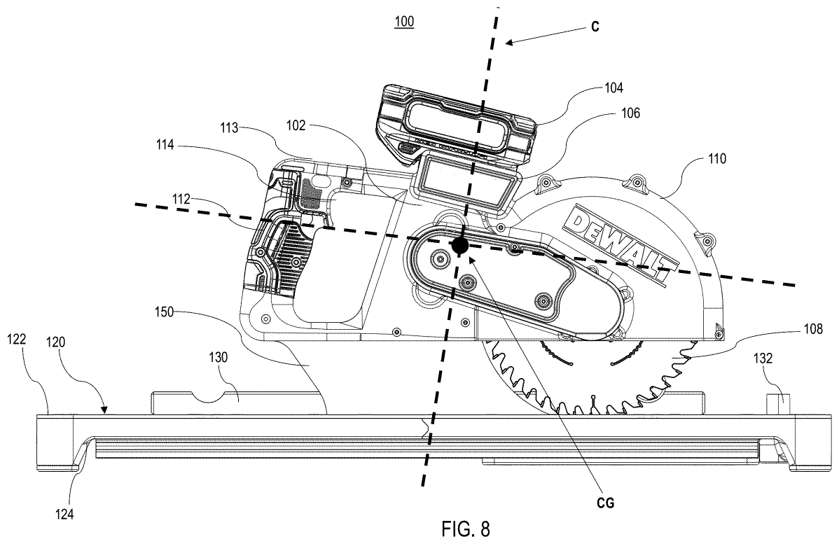

FIG. 1 depicts a rear, left isometric view of the multi-purpose saw 100. FIG. 2 depicts a front, left isometric view of the multi-purpose saw 100 of FIG. 1. FIG. 3 depicts a rear, right isometric view of the multi-purpose saw 100 of FIG. 1. FIG. 4 depicts a front, right isometric view of the multi-purpose saw 100 of FIG. 1. FIG. 5 depicts a front elevation view of the multi-purpose saw 100 of FIG. 1. FIG. 6 depicts a left side elevation view of the multi-purpose saw 100 of FIG. 1. FIG. 7 depicts a rear elevation view of the multi-purpose saw 100 of FIG. 1. FIG. 8 depicts a right side elevation view of the multi-purpose saw 100 of FIG. 1.

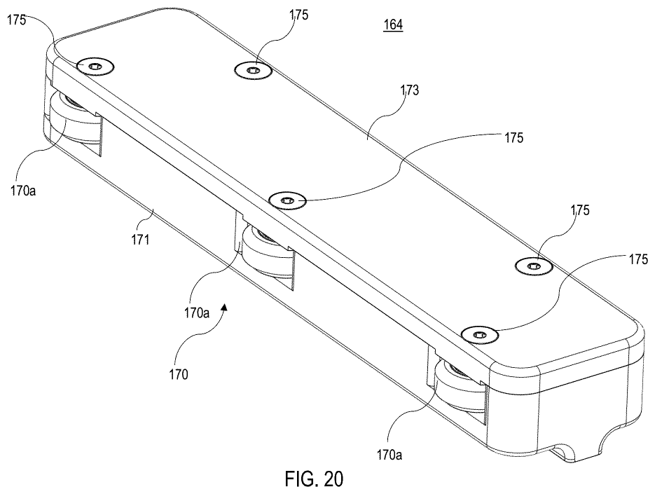

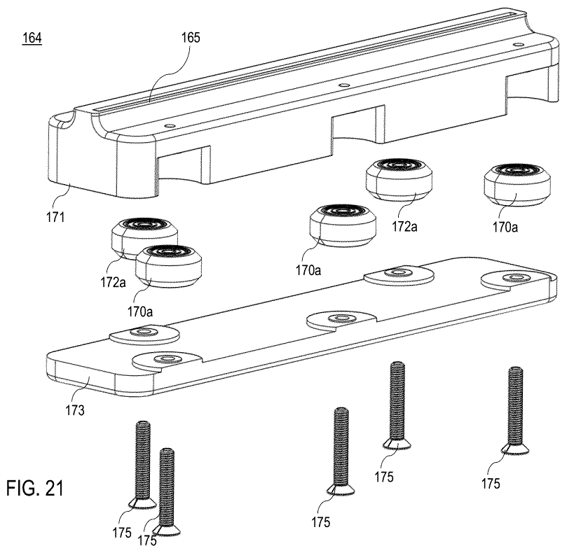

The multi-purpose saw 100 includes a tool housing 102 in which components such as, for example, a drive unit (e.g., a multi-motor drive unit) and a transmission (not shown in FIGS. 1-8 but both shown and discussed below with reference to FIGS. 20 and 21), are received. A battery pack 104 is removably coupled in a battery receptacle 106 defined by the tool housing 102, to supply power to the drive unit. The transmission outputs a rotational force that rotates a blade 108 in response to power supplied by the drive unit and the battery pack 104. The blade 108 is partially received in a blade housing 110. In an implementation, the blade housing 110 is semi-circular in shape to conform to the shape of the blade 108. The semi-circular shape of the blade housing 110 leaves a portion of the blade 108 exposed for interaction with a workpiece during operation of the multi-purpose saw 100, while functioning as a guard for the user.

The multi-purpose saw 100 includes a handle 112. The handle 112 includes a top handle portion 113. The handle 112 includes a trigger 114, which may be engaged and/or manipulated by a user, to provide for operation of the multi-purpose saw 100. During operation, the multi-purpose saw 100 may be operated by a single hand of the user gripping the handle 112. In some implementations, the multi-purpose saw 100 may be used ambidextrously. For example, the handle 112 may be gripped by one of a right hand or a left hand of the user. In some implementations, during operation, the multi-purpose saw 100 may be operated by both hands of the user with one hand gripping the handle 112 and the other hand gripping or pushing on the top handle portion 113. During two-handed operation of the multi-purpose saw 100, the multi-purpose saw 100 may also be used ambidextrously. For example, the handle 112 may be gripped by one of a right hand or a left hand of the user, and the top handle portion 113 may be gripped by the other of the right hand or the left hand of the user, to accommodate user preferences for operation of the multi-purpose saw 100.

In the example arrangement, the multi-purpose saw 100 includes a base 120. The base 120 provides a surface for supporting and positioning a workpiece for a cutting operation. The base 120 also may be referred to as a table or a worktable or the like. The base 120 includes a top surface 122 and a bottom surface 124. The top surface 122 of the base 120 provides a planar (or flat) and steady surface to support a workpiece so that accurate and straight cuts can be achieved. The top surface 122 of the base 120 may assist in securing the workpiece while a cut is being made.

The base 120 includes a plate 126 and the plate 126 includes an opening 128. In some implementations, the plate 126 may be referred to as a kerf plate and the opening 128 may be referred to as a kerf plate slot. The opening 128 is a extends from the top surface 122 to the bottom surface 124 of the base 120. At least a portion of the blade 108 penetrates through the opening 128.

The base 120 includes a first fence 130 and a second fence 132. The first fence 130 may also be referred to as a rip fence. The first fence 130 may be rectangular-shaped and is parallel to the opening 128 in the base 120. The first fence 130 is movable along a first set of tracks 134a, 134b in the top surface 122 of the base 120. The first set of tracks 134a, 134b may be straight tracks. The first fence 130 moves towards and away from the opening 128 across the top surface 122 of the base 120 along the first set of tracks 134a, 134b, while remaining parallel to the opening 128. The first fence 130 may be locked in place in any desired location along the first set of tracks 134a, 134b using a lever 138. The lever 138 may be lifted and pivoted away from the first fence 130 to an unlocked position, which frees the first fence 130 to move along the first set of tracks 134a, 134b. The lever 138 may be pushed and pivoted towards the first fence 130 to a locked position, which locks the first fence 130 in place in the first set of tracks 134a, 134b. When the lever 138 is in the locked position and the first fence 130 is locked in place, the first fence 130 remains static to secure the workpiece while the multi-purpose saw 100 is making a cut in the workpiece.

The second fence 132 may be referred to and function as a miter fence that may be used when making miter cuts. The second fence 132 may be oval-shaped and may have a first end 140 and a second end 142. The first end 140 may be a free end that is free to move relative to the base 120. The second end 142 may be a pivot point about which the first end 140 rotates and moves. The first end 140 may move along a third track 144 in the top surface 122 of the base 120. The third track 144 may be an arc-shaped track and that enables the second fence 132 to rotate from one position so the second fence 132 is approximately parallel to the opening 128 in the base 120 and another position so the second fence 132 is approximately perpendicular to the opening 128 in the base 120. The third track 144 may include detents (not shown) or stops to secure the first end 140 of the second fence 132 in a desired position. In some implementations, the first end 140 of the second fence 132 may be locked into any position along the third track 144. In some implementations, the first end 140 include a clamping mechanism that enables the second fence 132 to lock into a position along the third track 144. The clamping mechanism may be used in combination with detents or stops to secure the first end 140 in a desired position. In some implementations, just a clamping mechanism may be used without the detents or stops. The clamping mechanism may include an over-center clamp and/or level nested in the first end 140. In this manner, the second fence 132 may be used to make angled cuts in a workpiece at various different angles depending on the position of the second fence 132.

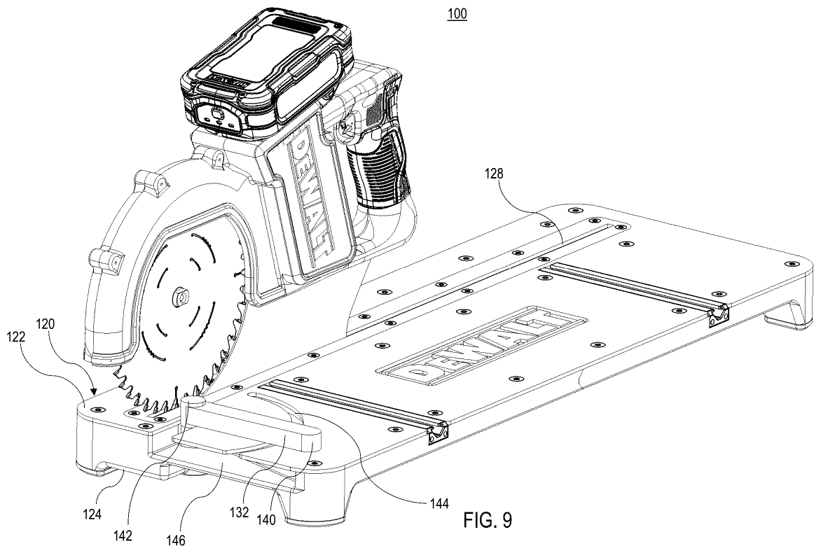

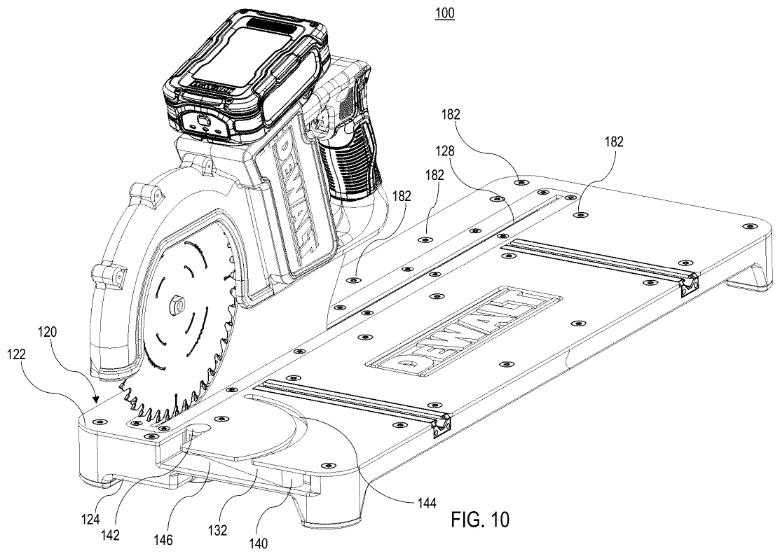

In some implementations, the second fence 132 may be movable from an operational state to a stored state (or stowed state). FIG. 9 depicts a front, left isometric view of the multi-purpose saw 100 of FIG. 1 with the second fence 132 in an operational state on the top surface 122 of the base 120. FIG. 10 depicts a front, left isometric view of the multi-purpose saw of FIG. 1 with the second fence in a stored state in an open cavity 146 between the top surface 122 and the bottom surface 124 of the base 120.

In the operational state, the second fence 132 is disposed on the top surface 122 of the base 120. As discussed above, the first end 140 is free to rotate about the second end 142, which functions as a pivot point. In the stored state, the second fence 132 is stored in the cavity 146 between the top surface 122 and the bottom surface 124 of the base 120. The cavity 146 may be sized to fit the second fence 132 within the base 120. To place the second fence 132 in the stored state, the first end 140 of the second fence 132 is forward and out of the third track 144 so that the second fence 132 is approximately parallel to the opening 128 in the base 120. Then, the second fence 132 is lowered (or dropped down) below the top surface 122 of the base 120 and rotated into the cavity 146. When the second fence 132 is in the stored state, the second fence 132 is approximately perpendicular to the opening 128. In this manner, the second fence 132 may be stored without physically having to remove the second fence 132 from the base 120. The second fence 132 remains attached to the base 120 as the second fence 132 is moved from the operational state to the stored state. The second fence 132 may be transitioned between the operational state and the stored state without separation from the base 120.

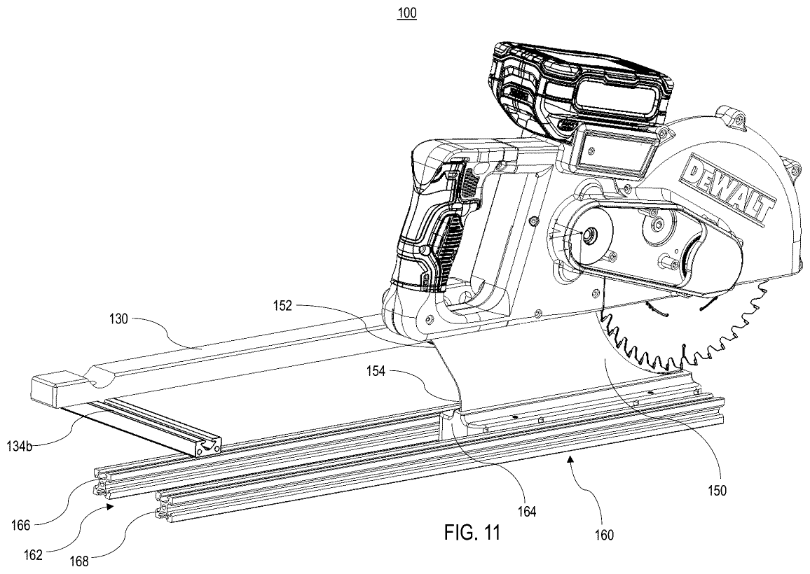

Referring back to FIGS. 1-8, the multi-purpose saw 100 is mounted (or coupled or fixed) to a support structure 150. In some implementations, the support structure 150 may be referred to as a riving knife. The support structure 150 serves to support the multi-purpose saw 100 above the base 120. The support structure 150 provides a structure to enable the multi-purpose saw 100 to move or slide along the base 120. The support structure 150 works in cooperation with a moving mechanism 160 below the top surface 122 of the base 120 (illustrated and described in detail below with respect to FIGS. 11-17). The moving mechanism 160 cooperates with the base 120. Additionally, the support structure 150 may function as a guard for the hand of the user during operation of the multi-purpose saw 100. In this manner, the support structure 150 is a barrier between the blade 108 and the hand of the user on the handle 112.

The support structure 150 supports the multi-purpose saw 100 through the base 120. More specifically, the support structure 150 supports the multi-purpose saw 100 through the opening 128 in the base 120. The support structure 150 passes through the opening 128 in the base 120. In this manner, the multi-purpose saw 100 and the support structure 150 are movable along the opening 128 in the base 120 to engage a workpiece on the top surface 122 of the base 120.

As best seen in FIGS. 5 and 7, the blade 108 and the support structure 150 define a plane B, which also may be referred to as a longitudinal plane or a cutting plane. In this manner, the blade 108 and the support structure 150 are coplanar. That is, both the blade 108 and the support structure 150 lie in the same plane B. In some implementations, the plane B is through the approximate center of the movable portion of the multi-purpose saw 100, where the center of the multi-purpose saw 100 is through a center of the handle 112, as best seen in FIG. 7. In this manner, the center of the handle 112 is coplanar with the blade 108 and the support structure 150.

As best seen in FIGS. 5 and 7, a center of gravity CG for the multi-purpose saw 100 may align along the plane B. In this manner, the center of gravity CG is aligned along the blade 108, the support structure 150, and the center of the handle 112. As seen in FIG. 8, the center of gravity CG may be centered in the middle of the movable multi-purpose saw components along the plane C. The center of gravity CG may be centered over the support structure 150. With the center of gravity CG aligned in plane of rotation of the blade 108, inertial forces that are generated during the operation of the multi-purpose saw 100 due to the speed of the blade 108, are substantially contained within the cutting plane B, further enhancing balance and stability during operation of the multi-purpose saw 100. The handle 112 is similarly aligned along this same plane B, together with the center of gravity CG of the movable portion of the multi-purpose saw 100 and the blade 108. This arrangement may further facilitate ambidextrous use of the multi-purpose saw 100 and may further enhance lateral balance and stability during operation of the multi-purpose saw 100. Additionally, with this arrangement, any rotating moments of inertia may be balanced about the support structure 150. Further, with this arrangement, any rotating moments of inertia offer no off-axis torque upon startup of the multi-purpose saw 100 or while the multi-purpose saw 100 is in operation, which increases accuracy of cuts on a workpiece and provides for stability of the multi-purpose saw 100 while making cuts on a workpiece.

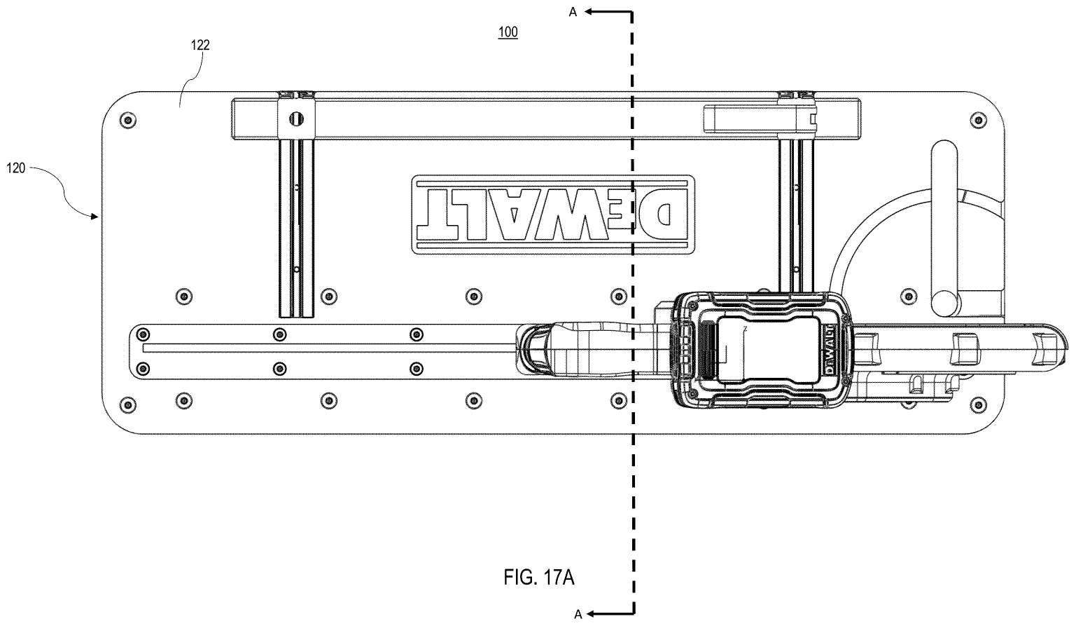

FIGS. 11-16 depict various views of the multi-purpose saw 100 without the base 120 to illustrate the arrangement of the multi-purpose saw 100, the support structure 150, and the moving mechanism 160. The base 120 is not illustrated in these views so that the moving mechanism 160, which is disposed below the top surface 122 of the base 120 can be seen. FIG. 17B depicts a view of the multi-purpose saw 100 with the base 120 that also illustrates the moving mechanism 160 to show the location of the moving mechanism 160 disposed below the top surface 122 of the base 120.

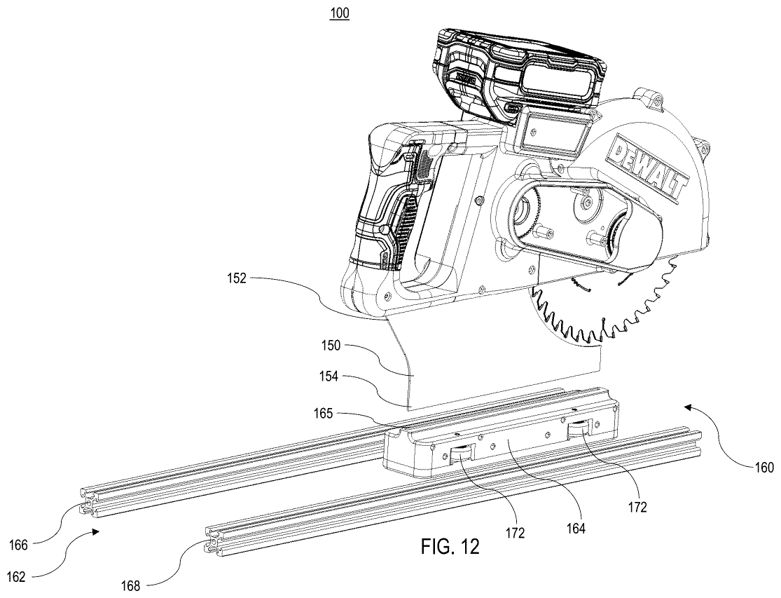

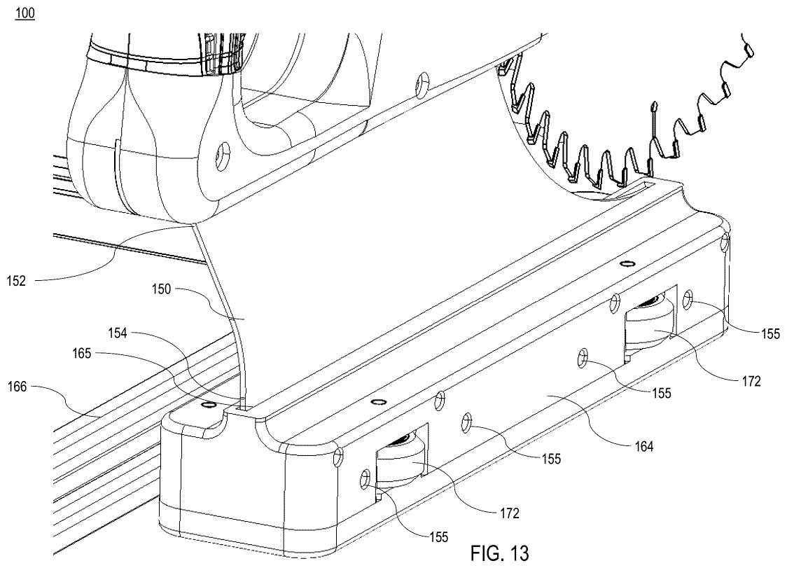

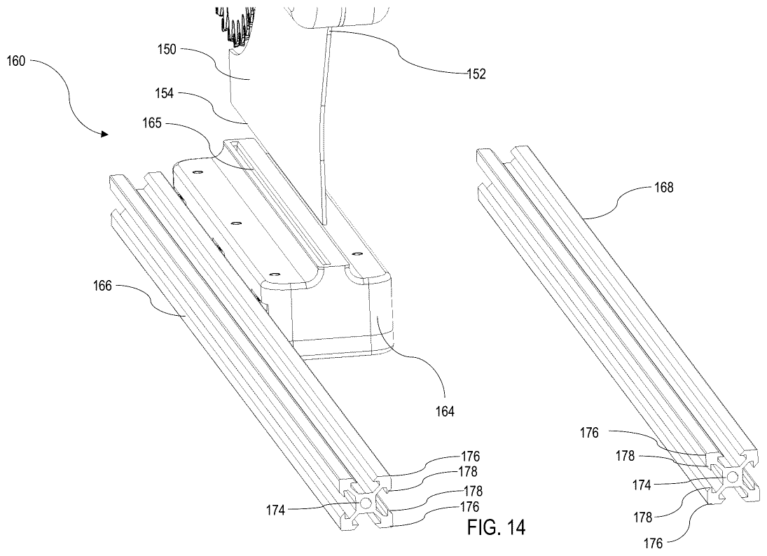

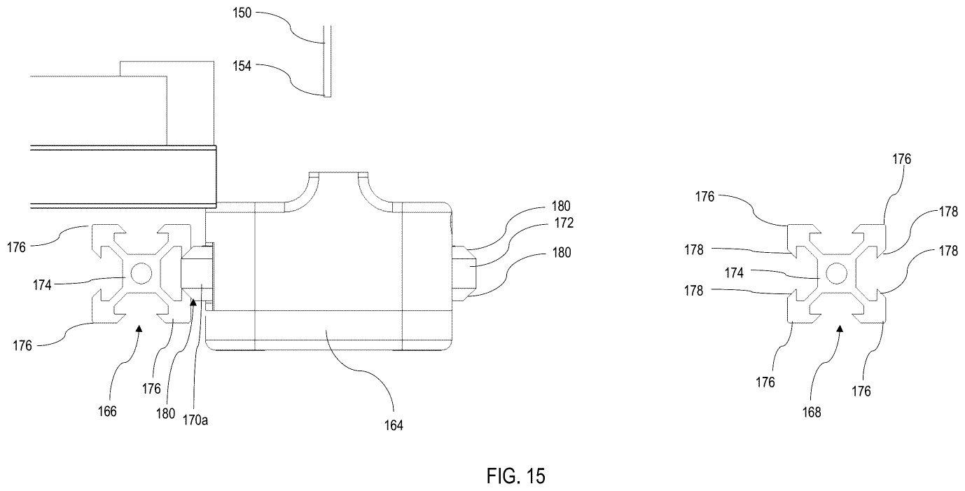

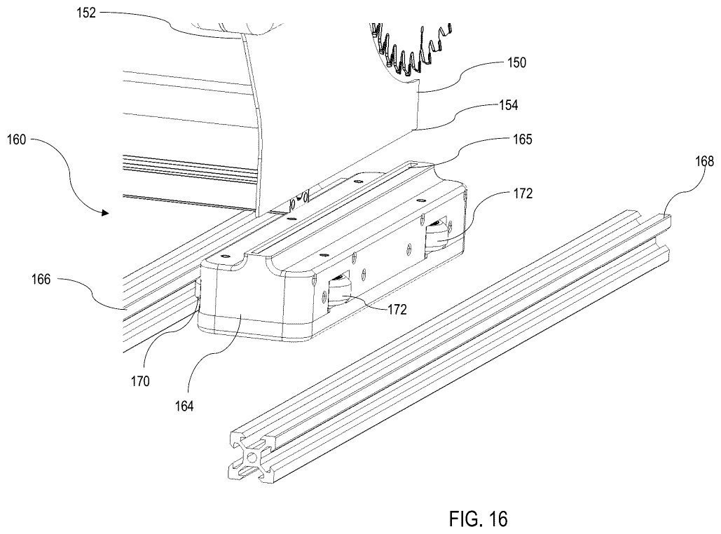

More specifically, FIG. 11 depicts a rear, right isometric view of the multi-purpose saw 100 of FIG. 1 with the base 120 removed, but with the first fence 130 and the second track 134b illustrated for reference. FIG. 12 depicts an exploded view of the multi-purpose saw 100 of FIG. 11 without the first fence 130 and the second track 134b. FIG. 13 depicts the detail area A of FIG. 3, without the base 120. FIG. 14 depicts a rear, left, partially exploded isometric view of the support structure 150 and the moving mechanism 160 of the multi-purpose saw 100. FIG. 15 depicts a front view of the partially exploded view of FIG. 14. FIG. 16 depicts a rear, right, partially exploded isometric view of the support structure 150 and the moving mechanism 160 of the multi-purpose saw 100. FIG. 17A depicts a top view of the multi-purpose saw 100 of FIG. 1. FIG. 17B depicts a cross-section view of the multi-purpose saw 100 of FIG. 1 with a partial cross-section of the base 120 taken along section line A-A of FIG. 17A.

As discussed above and illustrated, the support structure 150 is a structure that supports the multi-purpose saw 100 and that passes through the base 120. In FIGS. 11-17, the support structure 150 is illustrated along with the moving mechanism 160. In this manner, the support structure 150 connects or couples the multi-purpose saw 100 to the moving mechanism 160. In other words, the multi-purpose saw 100 is connected to or coupled to the moving mechanism 160 through the support structure 150.

The support structure 150 includes a first end 152 and a second end 154. The multi-purpose saw 100 is mounted to the first end 152 of the support structure 150 and the moving mechanism 160 is mounted to the second end 154 of the support structure 150. In other words, the first end 152 of the support structure 150 is connected to or coupled to the multi-purpose saw 100 and the second end 154 of the support structure 150 is connected to or coupled to the moving mechanism 160.

The moving mechanism 160 includes a rail system 162 and a carrier 164. The carrier 164 includes an opening 165 to receive and secure the support structure 150 to, for example, within the carrier 164. In this manner, the first end 152 of the support structure 150 is secured to, for example, within the tool housing 102. The second end 154 of the support structure 150 is secured to, for example, within the opening 165 of the carrier 164.

The carrier 164 also may be referred to as a block. The carrier 164 is configured to traverse (or roll) back and forth along the rail system 162. That is, the carrier 164 is free to travel along the rail system 162 and therefore the slot or opening 128. It follows then that the multi-purpose saw 100, which is coupled to the carrier 164 through the support structure 150, is also configured to traverse back and forth along the rail system 162 and therefore the slot or opening 128. That is, the multi-purpose saw 100 is free to travel along the rail system 162 through the support structure 150 and the carrier 164.

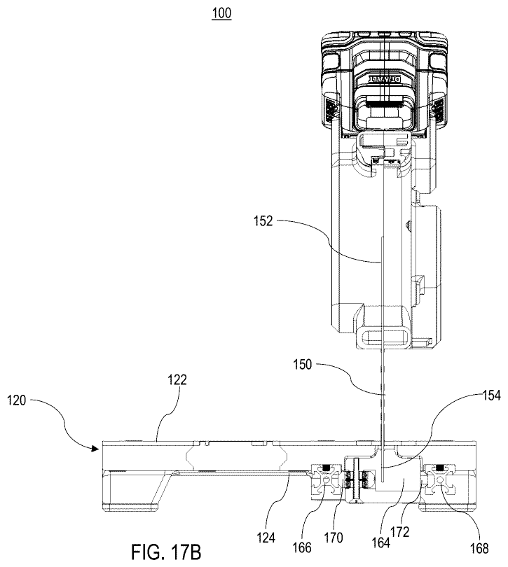

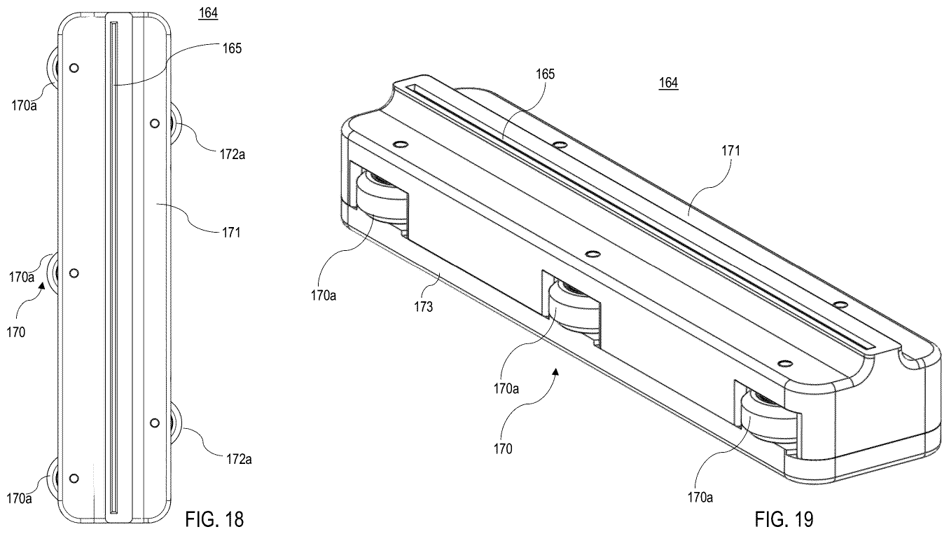

In an example implementation, the rail system 162 includes a first rail 166 and a second rail 168. In an example implementation, the carrier 164 further includes a first set of rollers 170 and a second set of rollers 172 that are configured to traverse (or roll) along the first rail 166 and the second rail 168, respectively. The first set of rollers 170 engages the first rail 166 and the second set of rollers 172 engages the second rail 168. The engagement of the first set of rollers 170 with the first rail 166 and the second set of rollers 172 with the second rail 168 enables the carrier 164 to traverse (or roll) back and forth along the rail system 162. In some implementations, the first set of rollers 170 includes multiple rollers such as, for example, three rollers. The second set of rollers 172 also may include multiple rollers, but may have a different number of rollers than the first set of rollers 170. For example, the second set of rollers 172 may include two rollers. In other example implementations, both the first set of rollers 170 and the second set of rollers 172 may include the same number of rollers. FIG. 18 depicts a top view of the carrier 164 of FIGS. 12-16. FIG. 19 depicts a rear, left isometric view of the carrier 164 of FIG. 18. FIG. 20 depicts a bottom, left isometric view of the carrier 164 of FIG. 18. FIG. 21 depicts front, left exploded view of the carrier 164 of FIG. 18. FIGS. 18-21 show the set of 5 rollers, offset from one another along the traversing axis to enable firm contact throughout the travel of the system.

As seen in more detail, the carrier 164 includes a top portion 171 and a bottom portion 173. The first set of rollers 170 include three rollers 170a and the second set of rollers 172 includes two rollers 172a, where the rollers 170a are offset from the rollers 172a. The rollers 170a and rollers 172a are clamped between the top portion 171 and the bottom portion 173. The top portion 171 and the bottom portion 173 are held together by fasteners 175.

FIG. 11 illustrates an assembled view of the moving mechanism 160. In FIG. 11, the carrier 164 is assembled in the rail system 162 between the first rail 166 and the second rail 168. The first set of rollers 170 and the second set of rollers 172 are not seen because they are engaged with the first rail 166 and the second rail 168, respectively.

In the exploded views of FIGS. 12, 14, 15 and 16, the second end 154 of the support structure 150 is illustrated above the opening 165 of the carrier 164. The second end 154 of the support structure 150 is sized to fit within the opening 165 of the carrier 164 such that the length of the second end 154 is approximately the same length as the opening 165. In the detail view of FIG. 13, the second end 154 is shown positioned in the opening 165 and clamped to the carrier 164 by one or more set screws 155. The one or more set screws 155 hold the second end 154 of the support structure 150 in the carrier 164. The carrier 164 holds the support structure 150 securely in place such that the multi-purpose saw 100 is stable when being moved and stable when making cuts in a workpiece.

FIG. 15 illustrates details of the structure of the first rail 166 and the second rail 168 and the engagement of the first rail 166 with one of the rollers of the first set of rollers 170. As illustrated, the first rail 166 and the second rail 168 include a center beam 174 and a set of arm beams 176. The set of arm beams 176 extend outward from the center beam 174. The set of arm beams 176 have a profile in the shape of an arrow with a set of flat sections 178 on each side of the arrow. The set of flat sections 178 provide an engagement surface for corresponding flat sections 180 on the first set of rollers 170 and the second set of rollers 172. As illustrated, one roller 170a of the first set of rollers 170 is engaged with the set of flat sections 178 on the first rail 166.

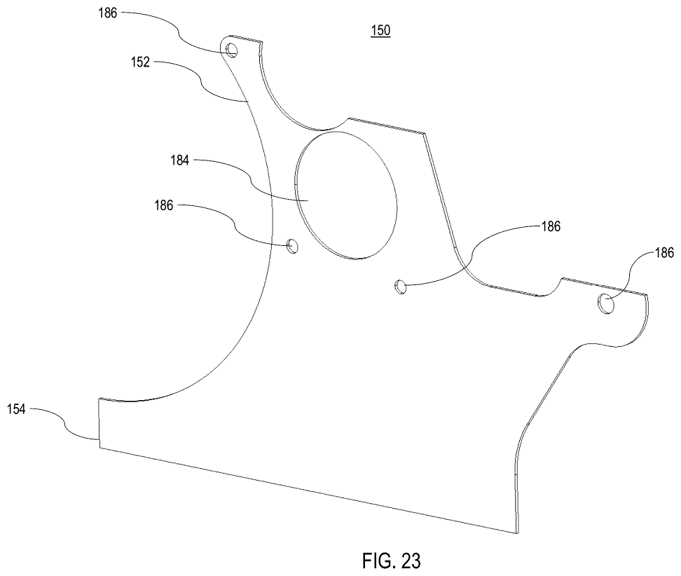

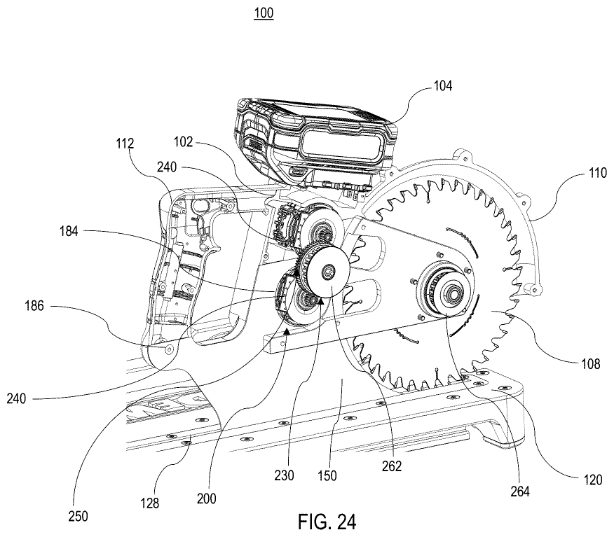

In one example implementation, the multi-purpose saw 100 may be assembled to the support structure 150 and the moving mechanism 160. The first end 152 of the support structure 150 is captured in the tool housing 102, as illustrated and described below in detail with respect to FIGS. 23 and 24. The support structure 150 is dropped through the opening 128 of the base 120, as seen in FIG. 1, and the second end 154 of the support structure 150 coupled to, for example captured in, the carrier 164 using one or more set screws 155, as illustrated in FIG. 13. The first rail 166 is mounted to the bottom surface 124 of the base 120. The first rail 166 may be secured to the base 120 using one or more fasteners 182 in the top surface 122 of the base 120, as seen in FIG. 10. One side of the carrier 164 is aligned with one of the rails. For example, the first set of rollers 170 is aligned to engage with the first rail 166. Then, the other rail is aligned to the carrier 164. For example, the second rail 168 is aligned to the second set of rollers 172. Finally, the second rail 168 is mounted to the bottom surface 124 of the base 120. It is understood that this is one example of an assembly process and that other assembly techniques may be used to assemble the multi-purpose saw 100 to the support structure 150 and the moving mechanism 160. Additionally, the order of assembly may be varied as well.

FIG. 17B illustrates the multi-purpose saw 100 assembled to the support structure 150 and the moving mechanism 160. As illustrated in FIG. 17B, the moving mechanism 160 is disposed on the underside of the base 120. Thus, there is no moving mechanism or other structure, like a gantry structure, on or above the top surface 122 of the base 120. In this manner, the arrangement of the multi-purpose saw 100 described and illustrated supports a sliding, movable saw above a base 120 without limiting or obstructing the horizontal rip cut capacity. The moving mechanism 160, which functions as the travel mechanism for the multi-purpose saw 100, is nested within bottom surface 124 of the base 120 so as not to interfere with the top surface 122 of the base 120 and any placement or support for a workpiece. That is, there are no overhead rails or rails above the top surface 122 of the base 120 that would impede the operation of the multi-purpose saw 100 on a workpiece or impede the placement or support of the workpiece. Additionally, the support structure 150 resides in the kerf of the cut by being coplanar with the blade 108.

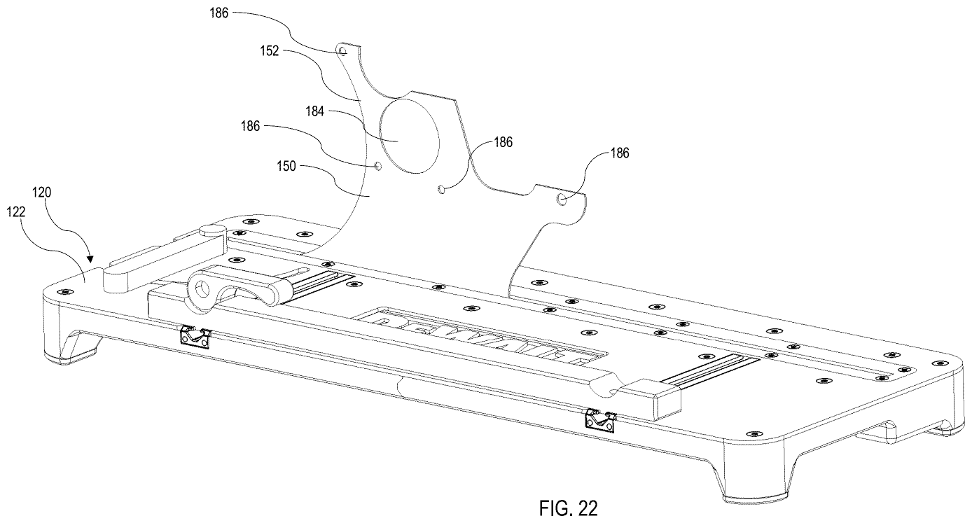

The support structure 150 is illustrated in more detail in FIGS. 22 and 23. FIG. 22 depicts a rear, left isometric view of the support structure 150 and the base 120. FIG. 23 depicts a rear, left isometric view of the support structure 150. As discussed above, the support structure 150 includes a first end 152 that is coupled to the tool housing 102 of the multi-purpose saw 100 (not shown in FIGS. 22 and 23 but shown and discussed in FIG. 24 below). Also as discussed above, the support structure 150 includes a second end 154 that is coupled to the carrier 164 of the moving mechanism 160.

The support structure 150 also includes other features in the first end 152 that function to secure the support structure 150 to the tool housing 102. The support structure 150 includes a cutout 184 that is sized and shaped to fit around one of the motors in the drive unit. The support structure 150 includes one or more holes 186 that are sized and shaped to fit around corresponding features in the tool housing 102 to hold the support structure 150 in place.

In some implementations, the support structure 150 is made of steel such as, for example, spring steel. Spring steel is a type of steel that includes properties of high yield strength, elasticity, hardness, and resilience. In some implementations, other types of steel may be used to make the support structure 150. In some implementations, other materials, including other metal or metal composites may be used to make the support structure 150.

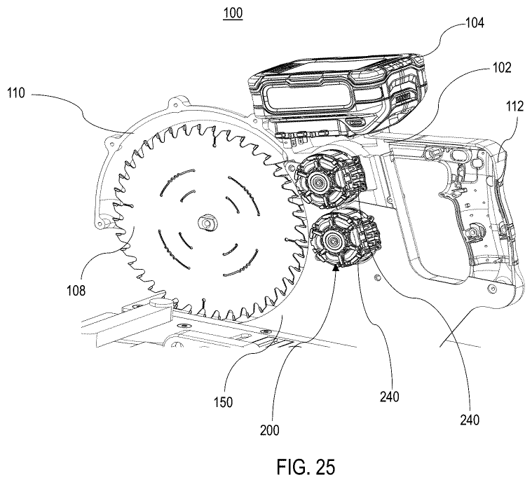

As mentioned above in the discussion of FIGS. 1-8, the multi-purpose saw 100 includes a drive unit and a transmission as illustrated in detail in FIGS. 24 and 25. FIG. 24 depicts a rear, right isometric view of the multi-purpose saw of FIG. 1 with the gears exposed. FIG. 25 depicts a rear, left isometric view of the multi-purpose saw of FIG. 1 with the motors exposed.

The drive unit 200 and the transmission 230 are housed within the tool housing 102 of the multi-purpose saw 100. The drive unit 200 includes a plurality of motors 240 that are engaged with a master gear 250 to drive a common shaft. Each of the plurality of motors 240 may be, for example, a Brushless Direct-Current (BLDC) motor.

In an embodiment, the drive unit 200 includes an arrangement of two motors 240. In an embodiment, the stators of the motors 240 are in a same radial plane with the blade 108. Further, rotational axes through the pinions of the motors 240 are parallel to a rotational axis through the center of the blade 108.

Motors 240 may be positioned with rotational axes that are parallel to the rotational axis of the blade 108. Each of the motors 240 may be positioned at approximately the same radial distance from the rotational axis of the blade 108 towards the rear of the multi-purpose saw 100. The motors 240 may be positioned towards the rear of the multi-purpose saw 100 between the handle 112 and blade 108 housed within the blade housing 110. By positioning the motors 240 in the plane of the blade 108 instead of adjacent to the plane of the blade 108, the multi-purpose saw 100 is narrower along the rotational axis of the blade 108 than other conventional saws. The narrower profile of the multi-purpose saw 100 may facilitate ambidextrous use of the multi-purpose saw 100.

In an embodiment, the transmission 230 may be included as part of the drive unit 200. In an embodiment, the transmission 230 may be considered separate from the drive unit 200, but cooperatively engaged with the drive unit 200. The transmission 230 includes the master gear 250 that engages and meshes with the pinions of the motors 240. In an embodiment, the transmission 230 includes an input pulley 262 and an output pulley 264 coupled together by a belt (not shown). The input pulley 262 engages with and is coupled to the master gear 250 and transfers rotational motion to the output pulley 264 via the belt. In an embodiment, the belt may include a timing belt or a toothed timing belt.

In an embodiment, the compact assembly of the multi-purpose saw 100 based on the location of the drive unit 200 and the transmission 230 provides for maximum visibility for the user making cuts on a workpiece with the multi-purpose saw 100. In an embodiment, as discussed above in detail, the center of gravity for the multi-purpose saw 100 is centered in the same plane as the support structure 150. A center of the handle 112 (in a left-right direction) is coplanar with the blade 108 and the feed direction of a workpiece. The handle 112 is also in line with the center of gravity of the multi-purpose saw 100. The rotating moments of inertia are balanced about the support structure 150. In this manner, there is no off-axis torque upon startup (when power is first supplied to the motors 240 to drive the blade 108) or during operation. The reduced system inertia decreases spin up and braking time.

As seen in FIG. 24, the cutout 184 in the support structure 150 is shaped and sized to fit around one of the motors 240 to secure the support structure 150 in the tool housing 102. Additionally, one or more holes 186 in the support structure 150 are used to secure the support structure 150 in the tool housing 102.

The motors 240 may be similar to the motors described in U.S. patent application Ser. No. 18/647,665, filed Apr. 26, 2024, and titled “Multi-Motor Drive System”, which is hereby incorporated by reference in its entirety, and thus duplicative detailed description thereof will be omitted except where necessary. Similarly, the drive unit 200 may include one or more of the features described above with respect to drive units of the circular saw including a motor adapter, a sleeve, a rear cover, and a front cover, where some of the components are not illustrated in this example, because they are described in U.S. patent application Ser. No. 18/647,665, filed Apr. 26, 2024, and titled “Multi-Motor Drive System”, and U.S. patent application Ser. No. 18/647,689, filed Apr. 26, 2024, and titled “Circular Saw,” both of which are hereby incorporated by reference in their entireties.

While a multi-purpose saw 100 is illustrated, this is merely one example of a power-driven tool that may be positioned above the top surface 122 of the base 120 and coupled to the moving mechanism 160 through the support structure 150. Other power-driven tools, including other types of saws, may use this arrangement to traverse along the top surface 122 of the base 120 to engage with a workpiece. That is, the power-driven tool is not limited to the example saw illustrated and described herein.

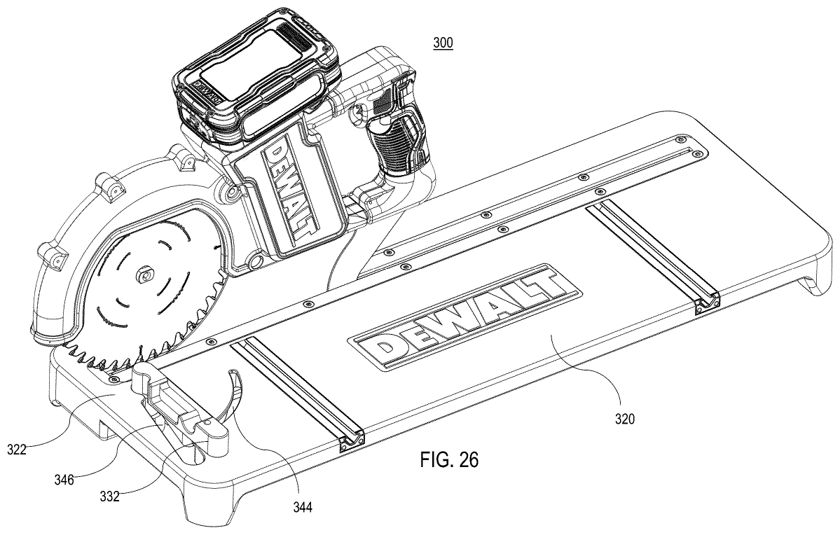

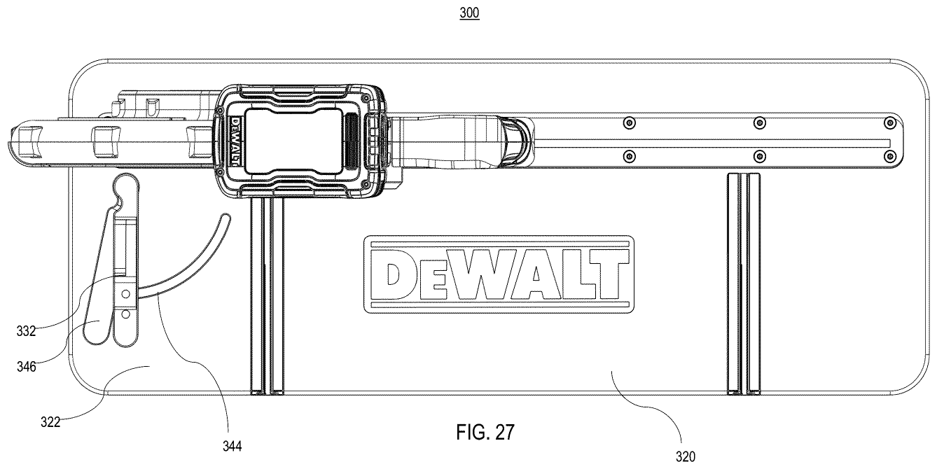

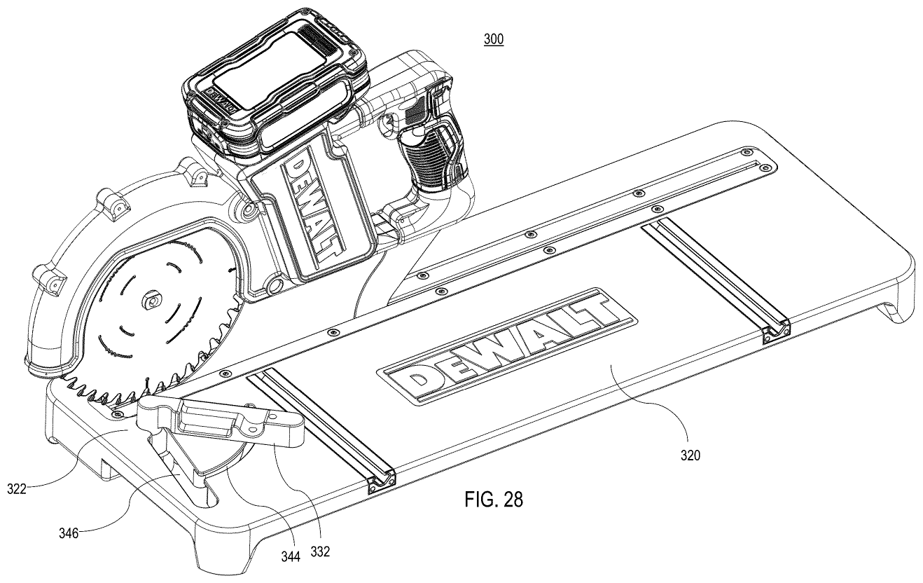

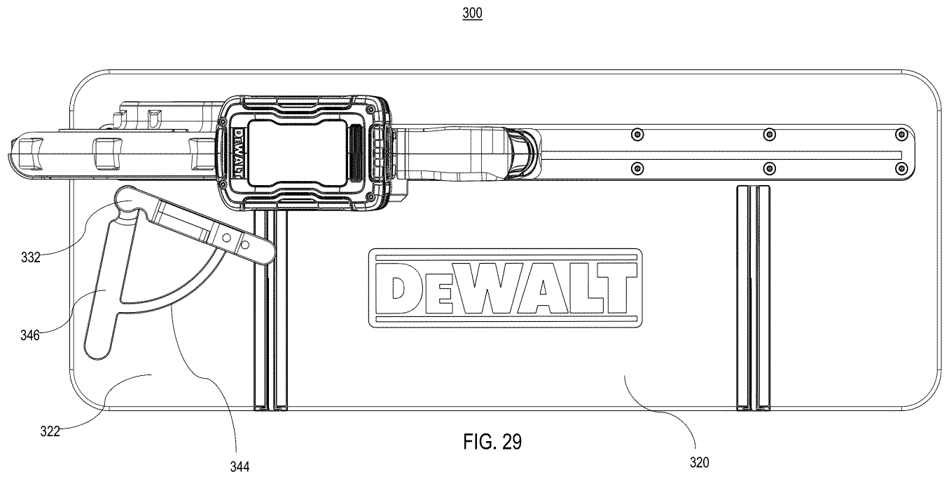

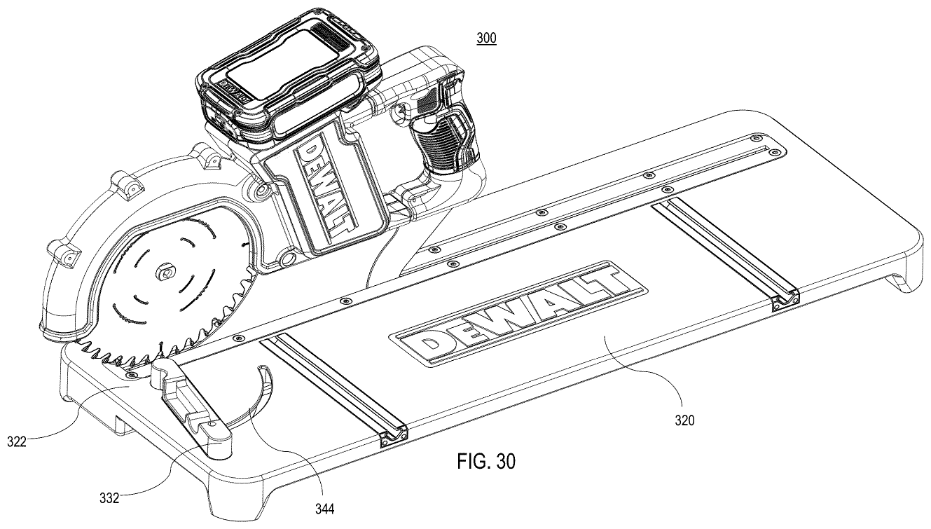

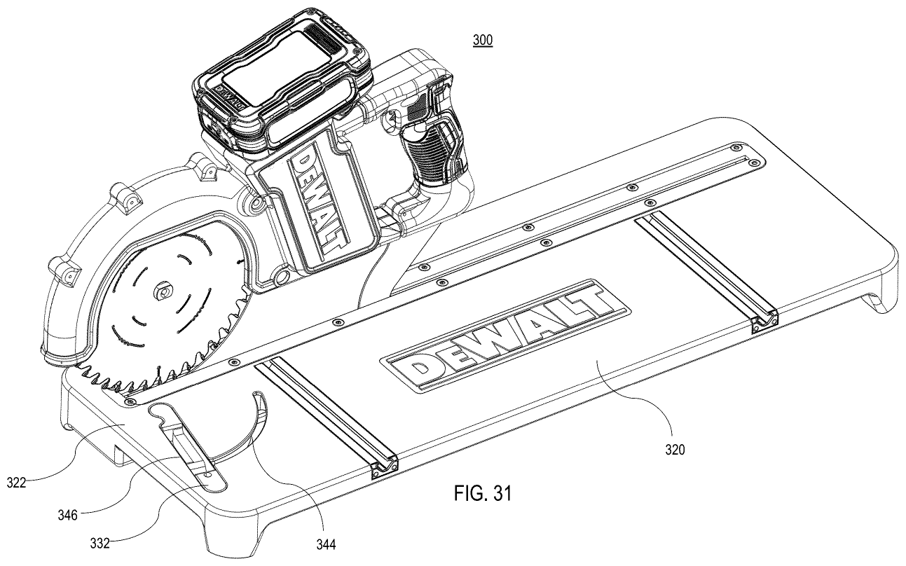

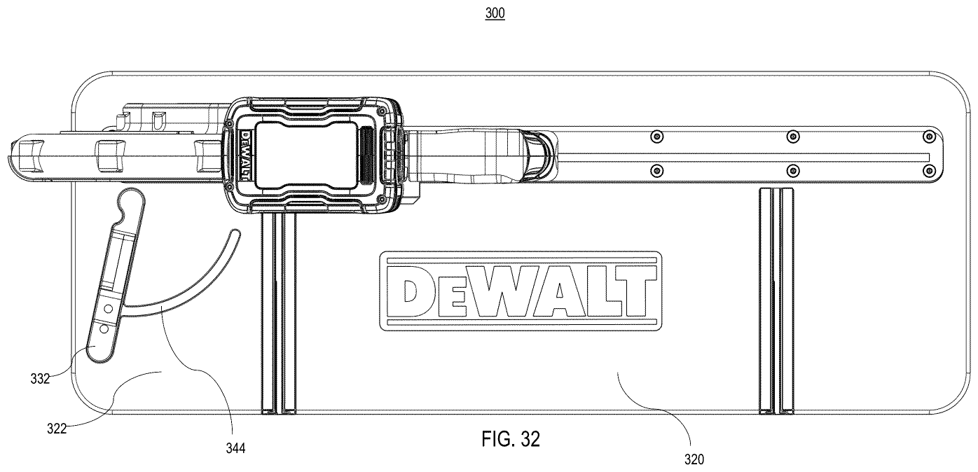

FIGS. 26-32 depict an example multi-purpose saw 300 having an alternate implementation of a second fence 332. FIG. 26 depicts a front, left isometric view of the multi-purpose saw 300 with the second fence 332 in a first position. FIG. 27 depicts a top view of the multi-purpose saw 300 with the second fence 332 in the first position. FIG. 28 depicts a front, left isometric view of the multi-purpose saw 300 with the second fence 332 in a second position. FIG. 29 depicts a top view of the multi-purpose saw 300 with the second fence 332 in the second position. FIG. 30 depicts a front, left isometric view of the multi-purpose saw 300 with the second fence 332 in a third position. FIG. 31 depicts a front, left isometric view of the multi-purpose saw 300 with the second fence stowed within the top surface 322 of the base 320—also referred to as a stowed position. FIG. 32 depicts a top view of the multi-purpose saw 300 with the second fence 332 in the stowed position.

The multi-purpose saw 300 may include the same features and functionality as the multi-purpose saw 100, as described above. The multi-purpose saw 300 may differ from the multi-purpose saw 100 by having the second fence 332 capable of being stowed in a cavity 346 in the top surface 322 of the base 320. The cavity 346 may be sized and shaped to receive the second fence 332 once it has rotated along the third track 344 and stops in a position above the cavity 346. The second fence 332 may be pushed down into the cavity 346 so that a top of the second fence 332 is flush with or recessed below the top surface 322. Similar to the second fence 132 discussed above, the second fence 332 may otherwise include the same features and functionality as the second fence 132.

The foregoing description has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “bottom,” “lower,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A power tool system, comprising:
a base having a top surface, a bottom surface, and an opening between the top surface and the bottom surface;
a support structure passing through the opening in the base, the support structure having a first end and a second end;
a power-driven tool positioned above the top surface of the base and mounted to the first end of the support structure; and
a moving mechanism disposed below the top surface of the base and coupled to the second end of the support structure.

2. The power tool system of claim 1, wherein the power-driven tool and the support structure are movable along the opening in the base to engage a workpiece positioned on the top surface of the base.

3. The power tool system of claim 1, wherein the support structure comprises a riving knife.

4. The power tool system of claim 1, wherein the moving mechanism comprises:
a rail system fixed to the base below the top surface; and
a carrier having an opening to receive and secure the second end of the support structure, the carrier movable along the rail system.

5. The power tool system of claim 4, wherein:
the rail system comprises a first rail and a second rail; and
the carrier comprises at least one roller to roll along the first rail and at least one roller to roll along the second rail.

6. The power tool system of claim 1, wherein the power-driven tool comprises a saw configured to rotatably drive a blade.

7. The power tool system of claim 6, wherein the blade is coplanar with the support structure.

8. The power tool system of claim 7, wherein:
the saw comprises a handle; and
a center plane of the handle is coplanar with the blade and the support structure.

9. The power tool system of claim 1, wherein:
the support structure defines a longitudinal plane; and
a center of gravity of the power-driven tool is aligned along the longitudinal plane.

10. The power tool system of claim 9, wherein:
the power-driven tool comprises a saw having a handle, the saw configured to rotatably drive a blade; and
the center of gravity of the saw is aligned along a center plane of the handle.

11. The power tool system of claim 1, wherein the base comprises:
a first fence that is parallel to the opening in the base; and
a second fence having a first position that is parallel to the opening in the base and a second position that is perpendicular to the opening in the base.

12. The power tool system of claim 11, wherein:
the first fence is movable across the top surface of the base in a position parallel to the opening in the base; and
the second fence pivots about a point from the first position to the second position.

13. The power tool system of claim 11, wherein:
an end of the base includes a cavity between the top surface and the bottom surface, the cavity is sized to receive the second fence; and
the second fence is rotatable and movable from the top surface of the base into the cavity between the top surface and the bottom surface.

14. The power tool system of claim 11, wherein:
the top surface of the base includes a cavity, wherein the cavity is sized to receive the second fence; and
the second fence is rotatable and movable into the cavity.

15. A power tool system, comprising:
a base having a top surface, a bottom surface, and an opening between the top surface and the bottom surface;
a support structure passing through the opening in the base, the support structure having a first end and a second end;
a power-driven tool positioned above the top surface of the base and mounted to the first end of the support structure, the power-driven tool including a blade aligned along a plane defined by the support structure with a center of gravity of the power-driven tool in alignment with the plane; and
a moving mechanism disposed below the top surface of the base and coupled to the second end of the support structure.

16. The power tool system of claim 15, wherein the power-driven tool includes a handle having a center of the handle aligned along the plane.

17. The power tool system of claim 15, wherein the center of gravity is located in an approximate middle of the power-driven tool.

18. The power tool system of claim 15, wherein the power-driven tool includes a saw.

19. A power tool system, comprising:
a base having a top surface, a bottom surface, and an opening between the top surface and the bottom surface;
a support structure passing through the opening in the base, the support structure having a first end and a second end;
a power-driven tool positioned above the top surface of the base and mounted to the first end of the support structure, the power-driven tool including a motor housing;
a multi-motor drive unit disposed in the motor housing to drive the power-driven tool; and
a moving mechanism disposed below the top surface of the base and coupled to the second end of the support structure.

20. The power tool system of claim 19, wherein the power-driven tool comprises a saw configured to rotatably drive a blade using the multi-motor drive unit.

21. The power tool system of claim 20, wherein the blade is coplanar with the support structure.

22. The power tool system of claim 21, wherein:
the saw comprises a handle; and
a center plane of the handle is coplanar with the blade and the support structure with a center of gravity of the saw aligned with the center plane of the handle, the blade, and the support structure.

23. The power tool system of claim 22, wherein the center of gravity is located in an approximate middle of the saw.
